(19) United States
(12) Patent Application Publication
(10) Pub. No.: US 2007/0095467 A1
(43) Pub. Date: May 3, 2007

(54) Method for joining tubular bodies with a connector

(76) Inventors: David C. Stieler, Lake Orion, MI (US); Dale L. Sleep, Clarkston, MI (US)

Correspondence Address: DYKEMA GOSSETT PLLC;Suite 300, 39577 Woodward Avenue, Bloomfield Hills, MI, 48304, US

(21) Appl. No.: 11/262,648

(22) Filed: Oct. 31, 2005

(51) Int. Cl. B32B 37/06

(52) U.S. Cl. 156/273.9; 156/293; 156/274.2

(57) ABSTRACT

A method of coupling components in a fluid handling system is provided. A connector and a tubular body having both a metallic layer and a polymeric layer are coupled with a thermoplastic material. The thermoplastic material is positioned proximate a port of the connector and the tubular body and connector are positioned relative to one another. A conductor is energized causing heat transfer from the metallic layer of the tubular body to the polymeric layer of the tubular body and to the thermoplastic material. The thermoplastic material is deformed and a bond is formed between the tubular body and the connector.

### BACKGROUND OF THE INVENTION

1. Field of the Invention

This invention relates to methods for coupling two or more components and, in particular, to a method for coupling plastic coated metal tubing using connectors and a thermoplastic bonding material to form a fluid tight, pressurized joint.

2. Discussion of Related Art

Motor vehicles may include various fluid handling systems, such as, but not limited to, fuel systems, power steering systems, heating and cooling systems, and hydraulic braking systems. These fluid handling systems may require the attachment of various tubular bodies, connectors and other components to create robust seals and fluid tight, pressurized joints for fluid handling.

A variety of methods are known for joining components of a fluid handling system. Ashland, Inc. has previously developed a process under the registered trademark “EMABOND” using induction welding to join two thermoplastic bodies. This process uses a bonding agent or resin disposed between the thermoplastic bodies and having metallic particles. A. Raymond Corp. has developed a process reflected in Published PCT patent application WO 01/21996 in which a tubular body is joined to a plastic connector using a meltable adhesive. Each of these methods, while satisfactory for its intended purpose, is used to join single material components (e.g., a thermoplastic body to another thermoplastic body or to a metallic body).

The inventors herein have recognized the benefits of using multi-layer tubing, and specifically plastic coated metal tubing, in fluid handling systems. See commonly assigned U.S. patent application Ser. No. 11/042,014 filed Jan. 25, 2005, the entire disclosure of which is incorporated herein by reference. The inventors have further recognized a need for a method for coupling components in a fluid handling system in which multi layer tubing and connectors are used.

### SUMMARY OF THE INVENTION

The present invention relates to a method for coupling components of a fluid handling system.

A method in accordance with the present invention includes the step of providing a first component, the first component comprising a tubular body having a metallic layer and a polymeric layer. The method also includes the step of providing a second component, the second component comprising a connector. The connector defines a first port. The method also includes the steps of providing a thermoplastic material proximate the first port of the connector and positioning one of the first and second components relative to another of the first and second components such that the tubular body of the first component is proximate the first port of the connector. Finally, the method includes the step of energizing a first conductor to deform the first thermoplastic material and form a bond between the first and second components.

A method in accordance with the present invention has significant advantages relative to conventional manufacturing methods for coupling fluid system components. The method provides an efficient process for coupling plastic coated metal tubing and connectors while creating a fluid tight, pressurized joint.

These and other advantages of this invention will become apparent to one skilled in the art from the following detailed description and the accompanying drawings illustrating features of this invention by way of example.

### BRIEF DESCRIPTION OF THE DRAWINGS

FIG. 1 is a cross-sectional view illustrating one embodiment of a fluid coupling formed in accordance with the present invention.

FIG. 2 is a cross-sectional view illustrating another embodiment of a fluid coupling formed in accordance with the present invention.

FIG. 3 is a cross-sectional view illustrating yet another embodiment of a fluid coupling formed in accordance with the present invention.

FIG. 4 is a cross-sectional view illustrating yet another embodiment of a fluid coupling formed in accordance with the present invention.

FIG. 5 is a flow chart illustrating a method in accordance with the present invention.

### DETAILED DESCRIPTION OF EMBODIMENTS OF THE INVENTION

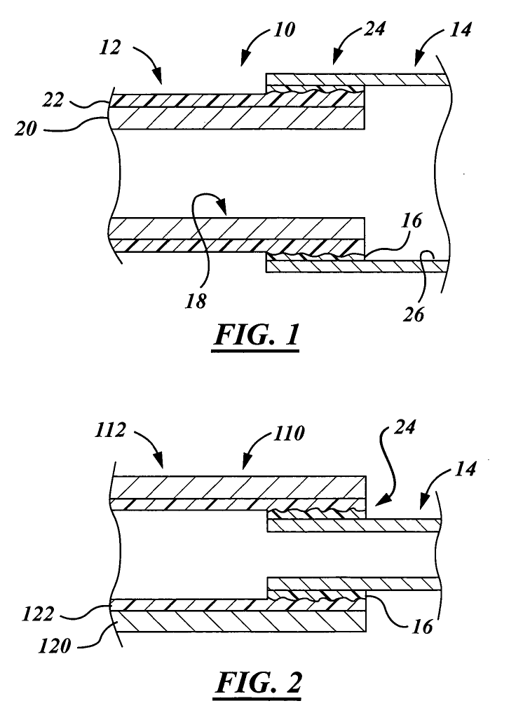

Referring now to the drawings wherein like reference numerals are used to identify identical components in the various views, FIG. 1 illustrates one embodiment of a fluid coupling 10 formed in accordance with the present invention. Fluid coupling 10 may be provided to transport fluid in a fluid handling system of a motor vehicle. Fluid handling systems constructed in accordance with the present invention may be particularly adapted for use in an automobile or light truck, but it should be understood that the inventive method described herein could be used for a variety of fluid handling systems for vehicular and non-vehicular applications. Coupling 10 includes at least two components 12, 14 and a thermoplastic bonding material 16.

Component 12 may comprise relatively rigid tubing for use in fluid handling. Component 12 defines a fluid passageway 18 in which fuel or another fluid may be stored and/or through which fuel or another fluid may be transported. Component 12 includes a metallic layer 20 and a polymeric layer 22. In the illustrated embodiment, metallic layer 20 is disposed inwardly of polymeric layer 22. It should be understood that additional laminate layers may be formed between layers 20, 22 and that either of layers 20, 22 may include a plurality of sublayers without departing from the spirit of the present invention.

Layer 20 may comprise steel. In a preferred embodiment layer 20 comprises aluminum. Layer 22 is polymeric and may comprise a plastic and, in particular, a thermoplastic. Layer 22 may or may not include a metallic or carbon or other non-metallic filler. In a preferred embodiment, layer 22 comprises nylon. Nylon refers to a family of polyamides generally characterized by the presence of the amide group, —CONH. In a preferred embodiment, the nylon is of a type known as nylon 12. It should be understood, however, that the type of nylon may vary and may be conductive (e.g., through the addition of carbon black) or non-conductive. Layer 22 may be pre-bonded to the layer 20 and may be extruded over the layer 20. In one constructed embodiment, the component is formed from nylon coated aluminum tubing sold under the registered trademark “HYCOT” by Hydro Aluminum Hycot USA, Inc. The aluminum layer of the tubing has a thickness of about 0.1 to about 1.2 mm. The nylon layer of the tubing has a thickness of between about 80 and about 500 microns and may measure about 150 microns.

Component 14 comprises a connector for connecting other components (e.g., for connecting component 12 to another component 12 or a different component). Component 14 may be made from a polymer such as a plastic. Component 14 defines at least one opening or port 24, but typically defines multiple ports used to connect multiple fluid conduits. In one embodiment of the invention, component 14 comprises a tee connectors having three separate ports 24. Component 14 may define one or more fluid passageways 26 extending between ports 24.

Thermoplastic bonding material 16 is provided to join components 12, 14. Material 16 may comprise a polyamide such as nylon or a partially aromatic polyamide. It should be understood, however, that other conventional bonding materials may be used. Material 16 is provided proximate a port 24 of component 14 where component 12 is to be joined to component 14. In the illustrated embodiment, one end of component 12 is disposed within one end of component 14 defining port 24 and material 16 is disposed on an inner surface of component 14 between component 14 and layer 22 of component 12. Material 16 may be relatively rigid and formed in a predefined shape and positioned within or around one end of connector 14 defining port 24. Alternatively, material 16 may be injected molded with connector 14 as connector 14 is formed.

Referring now to FIG. 2, an alternative embodiment of a fluid coupling 110 in accordance with the present invention is illustrated. Coupling 110 is substantially similar to coupling 10, but includes a component 112 having a metallic layer 120 disposed outwardly of the polymeric layer 122. In this embodiment, one end of component 14 defining a port 24 is inserted into one end of component 112 and the thermoplastic material is disposed on an outer surface of component 14 between component 14 and layer 122 of component 112.

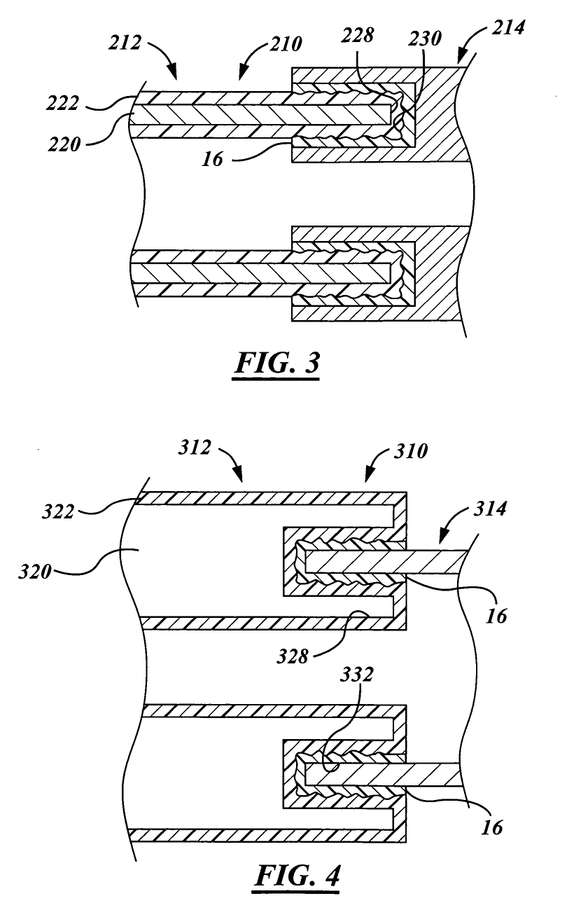

Referring now to FIG. 3, another alternative embodiment of a fluid coupling 210 in accordance with the present invention is illustrated. Coupling 210 is substantially similar to couplings 10, 110, but also differs in several respects. Coupling 210 includes a component 212 having a polymeric layer 222 disposed inwardly and outwardly of metallic layer 220. Polymeric layer 222 may also cover an end face 228 of metallic layer 220. Component 214 defines a recess 230 in one end face of component 214. Recess 230 is disposed between the radially inner and outer surfaces of component 214. Thermoplastic material 16 is disposed within recess 230 and, upon insertion of component 212 within recess 230 of component 214, is disposed between each of the walls of recess 230 and the polymeric layer 222 of component 212.

Referring now to FIG. 4, another alternative embodiment of a fluid coupling 310 in accordance with the present invention is illustrated. Coupling 310 is substantially similar to couplings 10, 110, 210, but also differs in several respects. Coupling 310 includes a component 312 having a polymeric layer 322 disposed inwardly and outwardly of metallic layer 320. Polymeric layer 322 may also cover an end face 328 of metallic layer 320. Component 312 further defines a recess 332 in end face 328. Recess 332 is disposed between the radially inner and outer surfaces of component 312. Thermoplastic material 16 is disposed within recess 332 and, upon insertion of one end of component 14 within recess 332 of component 312, material 16 is disposed between component 14 and the polymeric layer 322 covering each of the walls of recess 332.

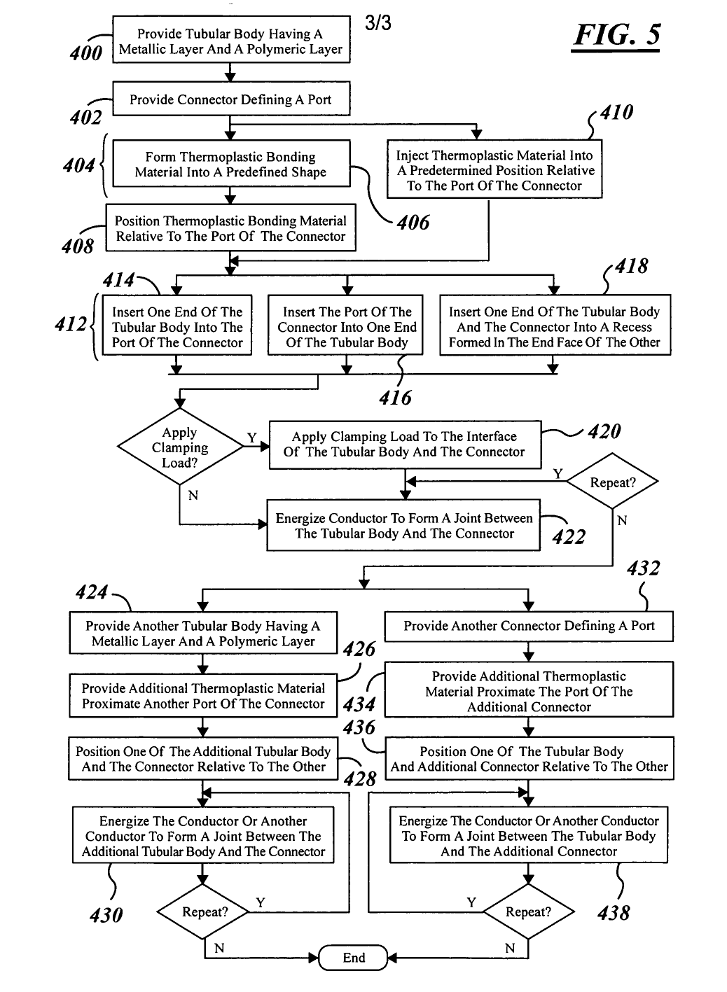

Referring now to FIG. 5, a method of coupling components of a fluid handling system in accordance with the present invention will be described. The inventive method may begin with the step 400 of providing a component, such as component 12, with a tubular body and having a metallic layer and a polymeric layer. The method may continue with the step 402 of providing another component, such as component 14, comprising a connector that defines a port.

The method may continue with the step 404 of providing a thermoplastic material 16 proximate the port of the connector. Step 404 may include several substeps. In one embodiment of the invention step 404 may include the substeps 406, 408 of forming material 16 into a predefined shape and positioning material 16 relative to the port of the connector. The predefined shape may be complementary to the shape of the port (e.g., the inner and/or outer surface of the connector) and/or may be designed to enable secure fastening of material 16 to the connector. In an alternative embodiment, step 404 may include the substep 410 of injecting material 16 into a predefined position relative to the port of the connector.

The method may continue with the step 412 of positioning one of the components relative to another of the components such that the tubular body of plastic coated metal component is proximate the port of the connector. Referring to FIG. 1, in accordance with one embodiment of the invention, step 412 may include the substep 414 of inserting one end of component 12 into port 24 of connector 14. Referring to FIG. 2, in accordance with another embodiment of the invention, step 412 may include the substep 416 of inserting port 24 of connector 14 into one end of the tubular body of component 112. Referring to FIGS. 3-4, in accordance with additional embodiments of the invention, step 412 may include the substep 418 of inserting one end of component 212 into a recess 230 formed in one end of component 214 between the radially inner and outer surfaces of component 214 or inserting one end of component 14 into a recess 332 formed in one end of component 312 between the radially inner and outer surfaces of component 312.

Referring again to FIG. 5, the inventive method may include the step of 420 of applying a clamping load to the components to be joined. The load may be applied using any of a variety of conventional tools and/or methods known in the art. The load may also be applied at multiple locations along the components.

The inventive method may finally include the step 422 of energizing a conductor to deform material 16 and form a bond between the components. The conductor may, for example, comprise a coil through which current is fed from a power source. The inventive method thus employs a form of induction welding. The inventors herein have recognized that the resulting electromagnetic field providing inductive energy to the metallic layer of the plastic coated metal component will result in heat transfer from the metallic layer to the polymeric layer and the thermoplastic material 16 and, at sufficient levels, will result in deformation of the polymeric layer and/or material 16 through melting to form a bond between the components. The resulting bond has significant strength. Further, the bond forms a hermetic seal such that fluid handling components may have fluid inlets and outlets sealingly coupled as shown in FIGS. 1-4. Referring again to FIG. 5, step 422 may be easily repeated one or more times to insure a proper hermetic seal is formed.

The inventive method may be used to form a coupling between two components. In accordance with one aspect of the invention, however, the inventive method may be used to couple additional components. For example, the method may be used co couple multiple plastic coated metal tubes using a connector. The method may therefore continue with the step 424 of providing another component comprising a tubular body and having a metallic layer and a polymeric layer. The method may further continue with the step 426 of providing additional thermoplastic material proximate another port of the connector. The material may be the same material or a different material relative to the material used to join the connector to the first plastic coated metal tube. The method may further continue with the step 428 of positioning one of the additional plastic coated metal tube component and the connector relative to the other as discussed hereinabove such that the additional plastic coated metal tube is proximate another port of the connector. Finally, the method may include the step 430 of energizing either the conductor used to connect the first plastic coated metal tube and the connector or another conductor. FIG. 5 illustrates steps 428, 430 as occurring subsequent to step 422. Step 428 alternatively may be performed prior to step 422 and steps 422, 430 may occur substantially simultaneously allowing the formation of multiple, fluid tight joints in a more efficient manner than was previously known. It should also be understood that, although not illustrated in FIG. 5, a step similar to step 420 may be performed prior to step 430 to assist in formation of the fluid coupling.

The method may be used to couple multiple connectors to opposite ends of a plastic coated metal tube. The method may therefore continue with the steps 432, 434 of providing another component comprising a connector defining a port and a thermoplastic material the port. The material may again be the same material or a different material relative to the material used to join the first connector to the plastic coated metal tube. The method may further continue with the step 436 of positioning one of the additional connector component and the plastic coated metal tube component relative to the other as discussed hereinabove such that the plastic coated metal tube is proximate the port of the newly added connector. Finally, the method may include the step 438 of energizing either the conductor used to connect the plastic coated metal tube and the first connector or another conductor. Again, FIG. 5 illustrates steps 436, 438 as occurring subsequent to step 422. Step 436 alternatively may be performed prior to step 422 and steps 422, 438 may occur substantially simultaneously allowing the formation of multiple, fluid tight joints in a more efficient manner than was previously known. It should also again be understood that, although not illustrated in FIG. 5, a step similar to step 420 may be performed prior to step 438 to assist in formation of the fluid coupling.

A method in accordance with the present invention has significant advantages relative to conventional manufacturing methods for coupling tubular bodies. The method provides an efficient process for coupling plastic coated metal tubing and connectors while creating fluid tight, pressurized joints. For example, multiple joints can be formed simultaneously using the inventive method and the inventive method avoids the need for brazing and other costly manufacturing processes. The inventive method also allows the formation of a strong, fluid tight joint that is capable of withstanding pressurized applications without the need for complex mechanical seals

While the invention has been shown and described with reference to one or more particular embodiments thereof, it will be understood by those of skill in the art that various changes and modifications can be made without departing from the spirit and scope of the invention.

We claim:

1. A method of coupling components of a fluid handling system, comprising the steps of:
providing a first component, said first component comprising a tubular body having a metallic layer and a polymeric layer;
providing a second component, said second component comprising a connector, said connector defining a first port;
providing a first thermoplastic material proximate said first port of said connector;
positioning one of said first and second components relative to another of said first and second components such that said tubular body of said first component is proximate said first port of said connector; and,
energizing a first conductor to deform said first thermoplastic material and form a bond between said first and second components.

2. The method of claim 1 wherein said metallic layer is disposed inward of said polymeric layer.

3. The method of claim 1 wherein said metallic layer is disposed outward of said polymeric layer.

4. The method of claim 1 wherein said metallic layer comprises aluminum.

5. The method of claim 1 wherein said polymeric layer comprises plastic.

6. The method of claim 1 wherein said polymeric layer comprises nylon.

7. The method of claim 1 wherein said step of providing a first thermoplastic material includes the substeps of:
forming said first thermoplastic material into a predefined shape; and,
positioning said first thermoplastic material relative to said first port.

8. The method of claim 1 wherein said step of providing a first thermoplastic material includes the substep of injecting said first thermoplastic material into a predefined position relative to said first port.

9. The method of claim 1, further comprising the steps of:
providing a third component, said third component comprising a tubular body having a metallic layer and a polymeric layer;
providing a second thermoplastic material proximate a second port of said connector;
positioning one of said second and third components relative to another of said second and third components such that said tubular body of said third component is proximate said second port of said connector; and,
energizing one of said first conductor and a second conductor to deform said second thermoplastic material and form a bond between said second and third components.

10. The method of claim 9 wherein said first and second thermoplastic materials have substantially the same composition.

11. The method of claim 9 wherein said step of energizing a first conductor and said step of energizing one of said first conductor and a second conductor occur substantially simultaneously.

12. The method of claim 1, further comprising the steps of:
providing a third component, said third component comprising a connector, said connector defining a first port;
providing a second thermoplastic material proximate said first port of said connector of said third component;
positioning one of said first and third components relative to another of said first and third components such that said tubular body of said first component is proximate said first port of said connector of said third component; and,
energizing a conductor to deform said second thermoplastic material and form a bond between said first and third components.

13. The method of claim 12 wherein said first and second thermoplastic materials have substantially the same composition.

14. The method of claim 12 wherein said step of energizing a first conductor and said step of energizing one of said first conductor and a second conductor occur substantially simultaneously.

15. The method of claim 1 wherein said positioning step includes the substep of inserting one end of said tubular body into said first port of said connector.

16. The method of claim 1 wherein said positioning step includes the substep of inserting said first port of said connector into one end of said tubular body.

17. The method of claim 1 wherein said positioning step includes the substep of inserting one end of one of said first and second components into a recess formed in one end of another of said first and second components between radially inner and outer surfaces of said another component.

18. The method of claim 1, further comprising the step of applying a clamping load to said first and second components.
